(19) United States
(12) Patent Application Publication
(10) Pub. No.: US 2002/0109391 A1
(43) Pub. Date: Aug. 15, 2002

(54) Child seat assembly having a crotch-strap subassembly

(76) Inventor: Herman J. Shie, Union, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 09/783,262

(22) Filed: Feb. 14, 2001

(51) Int. Cl. B60R 22/10

(52) U.S. Cl. 297/467

(57) ABSTRACT

A child seat assembly. A child-seat seat bottom has a first surface, a second surface located below the first surface, and a slot extending through the first surface and toward the second surface. The second surface has spaced-apart first and second notches. A crotch-strap subassembly has a member positioned in the slot and extending above the first surface and toward the second surface. The member includes a portion which is resiliently biased toward the second surface and into engagement with an aligned one of the notches. The member is movable in the slot and away from the second surface for disengagement of the portion from the aligned notch. When the portion is so disengaged, the member is movable across the slot to move the portion between the first and second notches.

### BACKGROUND OF THE INVENTION

The present invention relates generally to child seats, and more particularly to a child seat assembly having a crotch-strap subassembly.

Examples of child seats include child car seats for vehicles, child seat portions of child strollers, child high chairs, and child carriers. A child car seat typically includes a seat bottom, a seat back attached to the seat bottom, padding to cover the seat bottom and seat back, and a child restraint to secure the seated child. An example of a child restraint is a five-point harness. A typical five-point harness includes a crotch strap attached to the front area of the seat bottom and extending between the seated child's legs upward to attach to a harness buckle. The harness buckle also secures two shoulder belt portions and two waist belt portions. The shoulder belt portions extend from the harness buckle over the seated child's shoulders to the seat back. The waist belt portions extend to the sides of the rear area of the seat bottom or the sides of the lower area of the seat back. Another example of a child restraint is a three-point harness which is a five-point harness without the two waits belt portions.

In some conventional child car seats, the position of the crotch strap may be changed between more forward and more rearward locations to accommodate a growing child or to accommodate a child wearing winter clothing which is bulkier than summer clothing. In one known example involving a three-point harness, the crotch strap has a buckle insert which is inserted into a more forward buckle-receiving slot mechanism or a more rearward buckle-receiving slot mechanism. In another known example of a child car seat, the crotch strap may be removed from a more rearward slot by turning the child car seat over and detaching the crotch strap from the underside of the seat bottom. Then, the removed crotch strap is inserted in a more forward slot and attached to the underside of the seat bottom. Finally, the child car seat is turned right side up.

What is needed is a child seat, such as a child car seat, having an adjustable-position crotch strap which can remain attached to the seat bottom as the position of the crotch strap is being adjusted.

### SUMMARY OF THE INVENTION

A first expression of an embodiment of the invention is for a child seat assembly having a child-seat seat bottom and a crotch-strap subassembly. The seat bottom has a front-to-back axis, an upper surface, a lower surface located below the upper surface, and a slot substantially aligned with the axis and extending through the upper and lower surfaces. The lower surface has two or more axially-spaced-apart and downward-facing notches including first and second notches. The crotch-strap subassembly has a bar and a crotch strap. The bar is positioned in the slot and extends above the upper surface and below the lower surface. The crotch strap is attached to the bar. The bar includes an indexing rod which is located below the lower surface. The indexing rod is resiliently biased toward the lower surface and into engagement with an aligned one of the first and second notches. The bar is movable downward in the slot for disengagement of the indexing rod from the aligned one of the first and second notches. When the indexing rod is disengaged from the aligned one of the first and second notches, the bar is axially movable across the slot to move the indexing rod between the first and second notches. In one example, the seat bottom is a seat bottom of a child car seat. In one construction, the bar is pivotal about the indexing rod when the indexing rod is engaged in the aligned one of the first and second notches.

A second expression of an embodiment of the invention is for a child seat assembly having a child-seat seat bottom and a crotch-strap subassembly. The seat bottom has a first surface, a second surface located below the first surface, and a slot extending through the first surface and toward the second surface. The second surface has two or more spaced-apart notches including first and second notches. The crotch-strap subassembly has a member positioned in the slot and extending above the first surface and toward the second surface. The member includes a portion which is resiliently biased toward the second surface and into engagement with an aligned one of the first and second notches. The member is movable in the slot and away from the second surface for disengagement of the portion from the aligned one of the first and second notches. When the portion is disengaged from the aligned one of the first and second notches, the member is movable across the slot to move the portion between the first and second notches. In one example, the seat bottom is a seat bottom of a child car seat. In one construction, the member is pivotal about the portion when the portion is engaged in the aligned one of the first and second notches.

Several benefits and advantages are derived from the invention. The member/bar remains attached to the seat bottom as the position of the member/bar is being adjusted. When the crotch-strap subassembly is part of a three or five point harness, this allows (but does not require) the crotch strap to be adjusted while the child remains buckled in the harness. When the crotch-strap subassembly is constructed so the member/bar is pivotal, this allows the member/bar to be pivoted out of the way to allow easier placement of the child in the child seat and to provide easier removal of the child from the child seat.

### BRIEF DESCRIPTION OF THE DRAWINGS

FIG. 1 is a schematic, top planar view an embodiment of the child seat assembly of the invention with the crotch strap omitted for clarity;

FIG. 2 is a schematic, front elevational view of the child seat assembly of FIG. 1;

FIG. 3 is a schematic, side elevational view of the child seat assembly of FIG. 1 with the addition of the crotch strap;

FIG. 4 is a cross-sectional view of a portion of the child seat assembly of FIG. 1 taken along lines 4-4 of FIG. 1;

FIG. 5 is a cross-sectional view of a portion of the child seat assembly of FIG. 1 taken along lines 5-5 of FIG. 4; and

FIG. 6 is a front elevational view of the bar removed from the child seat assembly of FIG. 2.

### DETAILED DESCRIPTION

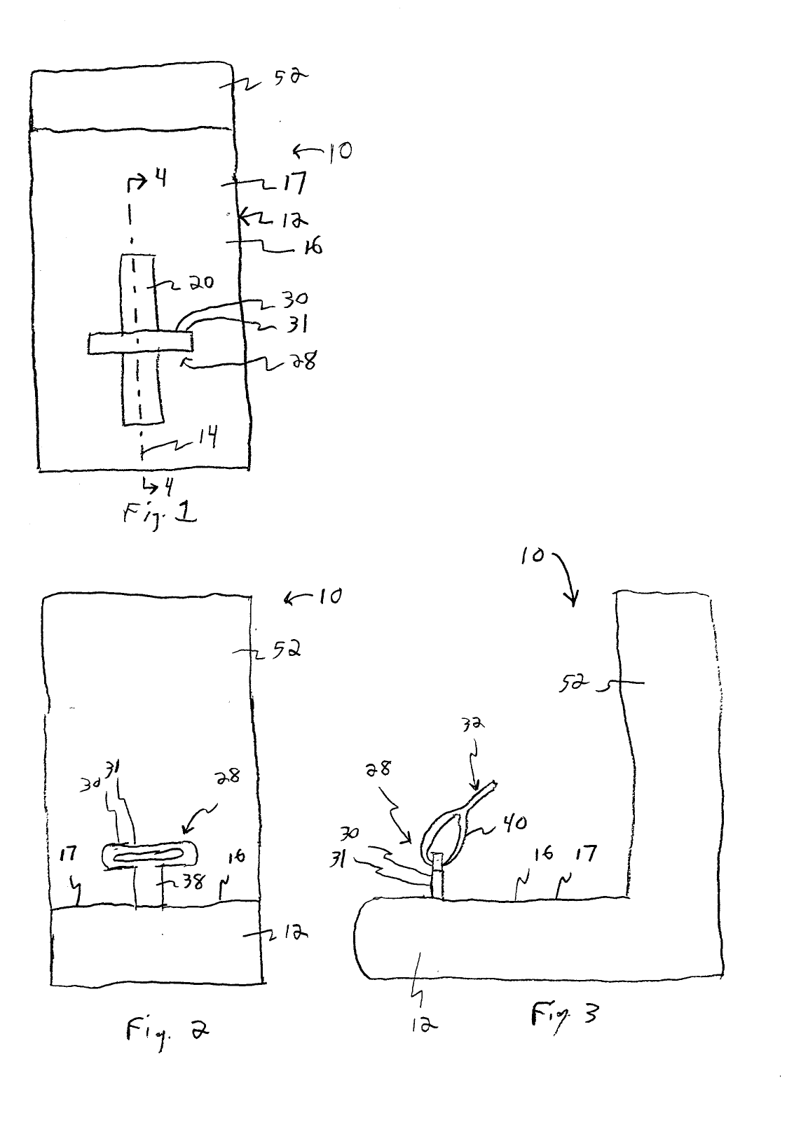

A first expression of an embodiment of the invention is for a child seat assembly 10 and is shown in FIGS. 1-6. The terminology “child seat” includes, without limitation, a child car seat for a vehicle, a child seat portion of a child stroller, a child high chair, and a child carrier. The terminology “child seat assembly” is a portion or all of a child seat. The term “child” includes a baby, an infant, and a child.

In the first expression, the child seat assembly 10 includes a child-seat seat bottom 12. The seat bottom 12 has a front-to-back axis 14, has an upper surface 16, has a lower surface 18 disposed below the upper surface 16, and has a slot 20. The slot 20 is substantially aligned with the axis 14 and extends through the upper and lower surfaces 16 and 18. The lower surface 18 has a plurality of axially-spaced-apart and downward-facing notches including first and second notches 22 and 24. The terms “upper” and “lower” are to be understood when the seat bottom 12 is in its use orientation. By “downward-facing” is meant facing below the horizontal (as opposed to facing horizontally or facing above the horizontal) when the seat bottom 12 is in its use orientation. Optionally, the plurality of spaced-apart notches also includes at least one additional notch 26. In one example, the seat bottom 12 is a child-car-seat seat bottom.

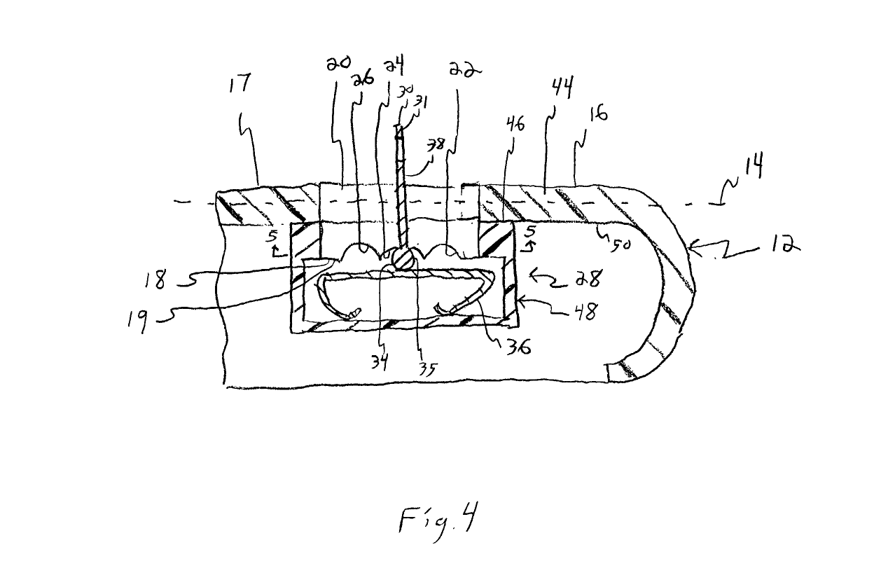

In the first expression, the child seat assembly 10 also includes a crotch-strap subassembly 28. The crotch-strap subassembly 28 has a bar 30 disposed in the slot 20 and extending above the upper surface 16 and below the lower surface 18. The terms “above” and “below” are to be understood when the seat bottom 12 is in its use orientation. The crotch-strap subassembly 28 also has a crotch strap 32 (only a portion of which is shown in FIG. 3) attached to the bar 30. The bar 30 includes an indexing rod 34 which is disposed below the lower surface 18. The indexing rod 34 is resiliently biased toward the lower surface 18 and into engagement with an aligned one of the first and second notches 22 and 24. The bar 30 is movable downward in the slot 20 for disengagement of the indexing rod 34 from the aligned one of the first and second notches 22 and 24. By “movable downward” is meant movable so that the indexing rod 34 moves out of the aligned one of the first and second notches 22 and 24. When the indexing rod 34 is disengaged from the aligned one of the first and second notches 22 and 24, the bar 30 is axially movable across the slot 20 to move the indexing rod 34 between the first and second notches 22 and 24. In one construction, the crotch strap 32 comprises webbing.

In one example, the crotch-strap subassembly 28 also includes a spring 36 disposed below and operatively engaging the indexing rod 34 for resiliently biasing the indexing rod 34 toward the lower surface 18 and into engagement with the aligned one of the first and second notches 22 and 24. In another example, not shown, the spring is disposed above the upper surface 16 and operatively engages an above-upper-surface portion of the bar 30, with the spring operatively engaging the upper surface to resiliently bias the above-upper-surface portion of the bar 30 upward and away from the upper surface 16 which resiliently biases the indexing rod 34 of the bar 30 toward the lower surface 18 and into engagement with an aligned one of the first and second notches 22 and 24. Other examples of the spring and its location are left to the artisan.

In one design, the bar 30 includes a shaft 38 aligned substantially perpendicular to the indexing rod 34. In one construction, the shaft 38 and the indexing rod 34 together define a monolithic structure. In another construction, the shaft and the indexing rod are separate components which are directly or indirectly attached together.

In one example, the crotch strap 32 includes a loop 40, the shaft 38 includes a through hole 42 disposed above the upper surface 16, and the loop 40 is engaged in the through hole 42. In one deployment, not shown, the other end of the crotch strap 32 has an insert, or buckle, to be engaged by a corresponding buckle, or insert on a web, to become part of a three or five point harness of a child restraint system. Other deployments of the other end of the crotch strap 32 are left to the artisan. In another example, not shown, the crotch strap 32 is attached to the indexing rod 34 below the lower surface 18, wherein the bar 30, above the indexing rod 34, has a front-elevational “U” shape with the top portions of the “U” of the indexing rod 34 attached to an above-upper-surface spring, with the loop 40 enclosing the lower portion of the “U” of the indexing rod 34, and with the crotch strap 32 extending upward from the loop 40 through the lower and upper surfaces 18 and 16 and through a slit in the above-upper-surface spring.

In one modification, the bar 30 is pivotal about the indexing rod 34 when the indexing rod 34 is engaged in the aligned one of the first and second notches 22 and 24. In one construction, the indexing rod 34 and the aligned one of the first and second notches 22 and 24 have matching circular surface portions, as seen in a side-elevational view, such as in FIG. 4.

In one variation, as seen in FIG. 4, the upper surface 16 is the top surface of a top wall 44 of the seat bottom 12, and the lower surface 18 is a bottom surface of a top wall 46 of an insert 48 which is attached to, and is considered a part of, the seat bottom 12. In another variation, not shown, the upper surface 16 is the top surface of a top wall 44 of the seat bottom 12, and the lower surface (having the first and second notches) is a bottom surface 50 of the top wall 44 of the seat bottom 12. Other structural variations providing the upper and lower surfaces 16 and 18 are left to the artisan. It is noted that an optional cushioning pad, not shown, with a slot corresponding to slot 20 may be placed on top of the upper surface 16.

In one design, the slot 20 is substantially equidistant from the sides of the seat bottom 12 and is disposed closer to the front than to the back of the seat bottom 12. In one application, a seat back 52 is monolithically, directly, or indirectly attached to the seat bottom 12. In one variation, not shown, the seat bottom and seat back are contoured to at least partially define a shell of an infant carrier, and an inverted “U”-shaped handle is attached to the side of the shell to carry the infant carrier. In another variation, not shown, the seat bottom and seat back have sides, and the child seat is adapted as a child car seat for installation on a vehicle seat. In an additional variation, not shown, legs are attached to the seat bottom, and a feeding tray is attached to arms which are attached to the seat bottom and seat back to at least partially define a child high chair. In a further variation, legs with wheels are attached to the seat bottom and a push handle is added to at least partially define a child stroller. Other variations are left to the artisan. In any variation, the crotch-strap subassembly 10 helps form a child restraint system, such as (but not limited to) a three or five point child harness. Other examples of child restraint systems having a crotch strap are left to the artisan.

In one construction, the bar 30 is a rigid bar. By “rigid” is meant that the bar 30 does not flex when resiliently biased toward the lower surface 18, when moved downward in the slot 22 for disengagement of the indexing rod 34, or, with the indexing rod 34 disengaged, when moved across the slot 20 to move the indexing rod 34 between the first and second notches 22 and 24. In one example, the bar 30 comprises metal with a plastic overmold, or with a paint, which provides thermal protection for a child who would otherwise contact the metal when the metal has been heated directly or indirectly by the sun.

In one variation, the spring 36 comprises a plate spring. In another variation, not shown, the spring comprises at least one coil spring which pushes up on a plate which contacts the bottom of the indexing rod and which is constrained to move only vertically upward and downward. Other spring variations are left to the artisan.

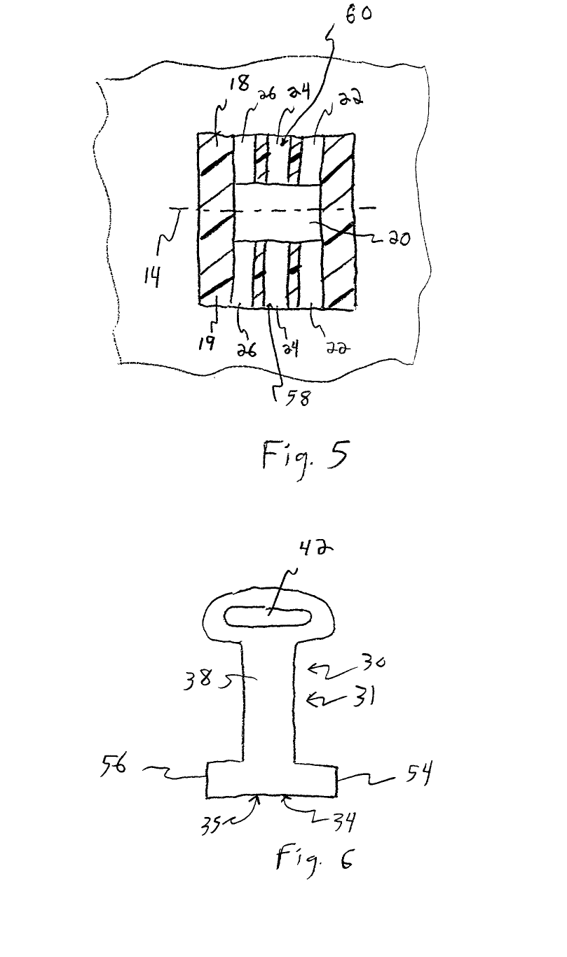

In one design, the indexing rod 34 has two opposing end portions defining first and second pins 54 and 56 which extend perpendicularly beyond the width of the shaft 38, as shown in FIG. 6, and the first and second notches 22 and 24 span the slot 20 in a direction substantially perpendicular to the axis 14, as shown in FIG. 5. In this design, the first pin 54 is engageable with a first portion 58 of an aligned one of the first and second notches 22 and 24, and the second pin 56 is engageable with a second portion 60 of the aligned one of the first and second notches 22 and 24, wherein the first and second portions 58 and 60 are disposed on opposite sides of the slot 20. In another design, not shown, the indexing rod 34 does not extend across the end of the shaft 38. Instead, in this other design, the indexing rod 34 is a first pin 54 which extends perpendicularly outward from the shaft 38, and there is included another indexing rod which is a second pin 56 which is coaxially aligned with the first pin and which extends perpendicularly outward from the other side of the shaft 38. Other designs involving one or more indexing rods are left to the artisan.

In operation, in one example, the user pushes down on the bar 30 (to overcome the resiliently-upwardly-biasing force of the spring 36) to disengage the indexing rod 34 from an aligned-one of the first and second notches 22 and 24. While keeping the bar 30 pushed down, the user axially moves the bar 30 across the slot 20 to a new desired axial location. Then, the user releases the bar 30, and the spring 36 resiliently upwardly biases the indexing rod 34 into engagement with the newly-aligned one of the first and second notches 22 and 24.

A second expression of an embodiment of the invention is for a child seat assembly 10 and is shown in FIGS. 1-6. The terminology “child seat” includes, without limitation, a child car seat for a vehicle, a child seat portion of a child stroller, a child high chair, and a child carrier. The terminology “child seat assembly” is a portion or all of a child seat. The term “child” includes a baby, an infant, and a child.

In the second expression, the child seat assembly 10 includes a child-seat seat bottom 12. The seat bottom 12 has a first surface 17, has a second surface 19 disposed below the first surface 17 and has a slot 20. The slot 20 extends through the first surface 17 and toward the second surface 19. The second surface 19 has a plurality of spaced-apart notches including first and second notches 22 and 24.

In the second expression, the child seat assembly 10 also includes a crotch-strap subassembly 28. The crotch-strap subassembly 28 has a member 31 disposed in the slot 20 and extending above the first surface 17 and toward the second surface 19. The terms “above” and “below” are to be understood when the seat bottom 12 is in its use orientation. The member 31 includes a portion 35 which is resiliently biased toward the second surface 19 and into engagement with an aligned one of the first and second notches 22 and 24. The member 31 is movable in the slot 20 and away from the second surface 19 for disengagement of the portion 35 from the aligned one of the first and second notches 22 and 24. When the portion 35 is disengaged from the aligned one of the first and second notches 22 and 24, the member 31 is movable across the slot 20 to move the portion 35 between the first and second notches 22 and 24.

As can be appreciated by those skilled in the art, the child seat assembly of the above-described second expression more broadly describes the embodiment shown in the figures and more broadly describes the above-described child seat assembly of the first expression. Thus, all of the descriptions, examples, designs, variations, applications, and constructions, etc. associated with the first expression of the child seat assembly are applicable, but not required, as descriptions, examples, designs, variations, applications, and constructions, etc. of the second expression of the child seat assembly when the member 31 is the bar 30, the portion 35 is the indexing rod 34, the first surface 17 is the upper surface 16, and the second surface 19 is the lower surface 18.

In a first example of the child seat assembly 10 of the second expression, the second surface 19 faces downward, and the first and second notches 22 and 24 face downward. In this first example, the portion 35 is resiliently biased upward toward the second surface and into engagement with an aligned one of the first and second notches 22 and 24. In this first example, the member 31 is movable downward in the slot 20 for disengagement of the portion 35 from the aligned one of the first and second notches 22 and 24.

In a second example, not shown, of the child seat assembly 10 of the second expression, the second surface 19 faces upward, and the first and second notches 22 and 24 face upward. In this second example, the portion 35 is resiliently biased downward toward the second surface and into engagement with an aligned one of the first and second notches 22 and 24. In this second example, the member 31 is movable upward in the slot 20 for disengagement of the portion 35 from the aligned one of the first and second notches 22 and 24.

In a third example, not shown, of the child seat assembly 10 of the second expression, the member 31 is not a bar, and the portion 35 is not a rod. Particular designs of the member 31 and the portion 35 are left to the artisan.

In one application, the child-seat seat bottom 12 of the second expression is a child-car-seat seat bottom. In one variation, the crotch-strap subassembly 28 also includes a spring 36 operatively engaging the portion 35 for resiliently biasing the portion 35 toward the second surface 19 and into engagement with the aligned one of the first and second notches 22 and 24. In one design, the crotch-strap subassembly 28 also includes a crotch strap 32 attached to the member 31, and wherein at least some of the crotch strap 32 is disposed above the first surface 17. In one modification, the member 31 is pivotal about the portion 35 when the portion 35 is engaged in the aligned one of the first and second notches 22 and 24. In one construction, the plurality of spaced-apart notches of the second expression also includes at least one additional notch 26.

Several benefits and advantages are derived from the invention. The member/bar remains attached to the seat bottom as the position of the member/bar is being adjusted. When the crotch-strap subassembly is part of a three or five point harness, this allows (but does not require) the crotch strap to be adjusted while the child remains buckled in the harness. When the crotch-strap subassembly is constructed so the member/bar is pivotal, this allows the member/bar to be pivoted out of the way to allow easier placement of the child in the child seat and to provide easier removal of the child from the child seat.

The foregoing description of several expressions of an embodiment of the invention has been presented for purposes of illustration. It is not intended to be exhaustive or to limit the invention to the precise form disclosed, and obviously many modifications and variations are possible in light of the above teaching. It is intended that the scope of the invention be defined by the claims appended hereto.

1. A child seat assembly comprising:
a) a child-seat seat bottom having a first surface, a second surface disposed below the first surface, and a slot extending through the first surface and toward the second surface, wherein the second surface has a plurality of spaced-apart notches including first and second notches; and
b) a crotch-strap subassembly having a member disposed in the slot and extending above the first surface and toward the second surface, wherein the member includes a portion which is resiliently biased toward the second surface and into engagement with an aligned one of the first and second notches, wherein the member is movable in the slot and away from the second surface for disengagement of the portion from the aligned one of the first and second notches, and, when the portion is disengaged from the aligned one of the first and second notches, the member is movable across the slot to move the portion between the first and second notches.

2. The child seat assembly of claim 1, wherein the child-seat seat bottom is a child-car-seat seat bottom.

3. The child seat assembly of claim 1, wherein the crotch-strap subassembly also includes a spring operatively engaging the portion for resiliently biasing the portion toward the second surface and into engagement with the aligned one of the first and second notches.

4. The child seat assembly of claim 1, wherein the crotch-strap subassembly also includes a crotch strap attached to the member, and wherein at least some of the crotch strap is disposed above the first surface.

5. The child seat assembly of claim 1, wherein the member is pivotal about the portion when the portion is engaged in the aligned one of the first and second notches.

6. The child seat assembly of claim 1, wherein the plurality of spaced-apart notches also includes at least one additional notch.

7. A child seat assembly comprising:
a) a child-seat seat bottom having a front-to-back axis, an upper surface, a lower surface disposed below the upper surface, and a slot substantially aligned with the axis and extending through the upper and lower surfaces, wherein the lower surface has a plurality of axially-spaced-apart and downward-facing notches including first and second notches; and
b) a crotch-strap subassembly having a bar disposed in the slot and extending above the upper surface and below the lower surface, and having a crotch strap attached to the bar, wherein the bar includes an indexing rod which is disposed below the lower surface, wherein the indexing rod is resiliently biased toward the lower surface and into engagement with an aligned one of the first and second notches, wherein the bar is movable downward in the slot for disengagement of the indexing rod from the aligned one of the first and second notches, and, when the indexing rod is disengaged from the aligned one of the first and second notches, the bar is axially movable across the slot to move the indexing rod between the first and second notches.

8. The child seat assembly of claim 7, wherein the child-seat seat bottom is a child-car-seat seat bottom.

9. The child seat assembly of claim 7, wherein the crotch-strap subassembly also includes a spring disposed below and operatively engaging the indexing rod for resiliently biasing the indexing rod toward the lower surface and into engagement with the aligned one of the first and second notches.

10. The child seat assembly of claim 7, wherein the bar includes a shaft aligned substantially perpendicular to the indexing rod.

11. The child seat assembly of claim 10, wherein the shaft and the indexing rod together define a monolithic structure.

12. The child seat assembly of claim 10, wherein the crotch strap includes a loop, wherein the shaft includes a through hole disposed above the upper surface, and wherein the loop is engaged in the through hole.

13. The child seat assembly of claim 7, wherein the bar is pivotal about the indexing rod when the indexing rod is engaged in the aligned one of the first and second notches.

14. The child seat assembly of claim 7, wherein the plurality of spaced-apart notches also includes at least one additional notch.

15. The child seat assembly of claim 7, wherein the crotch strap comprises webbing.
